(19) United States
(12) Patent Application Publication
(10) Pub. No.: US 2017/0298906 A1
(43) Pub. Date: Oct. 19, 2017

(54) WIND-WATER-LIGHT-MAGNETISM-AIR FIVE-ENERGY INTEGRATED POWER GENERATION DEVICE

(71) Applicant: Polyunion Textile (Shenzhen) Factory, Yueqing City (CN)

(72) Inventors: Xudong LIU, Yueqing (CN); Gongren LIU, Yueqing (CN); Geng LIU, Yueqing (CN); Honglu LIU, Yueqing (CN); Chang JIN, Yueqing (CN)

(21) Appl. No.: 15/640,383

(22) Filed: Jun. 30, 2017

Related U.S. Application Data
(63) Continuation of application No. PCT/CN2016/110936, filed on Dec. 20, 2016.

(30) Foreign Application Priority Data
Dec. 31, 2015 (CN) 201511029739.6

(51) Int. Cl. F03D 9/00; F03D 9/25; H02K 7/18

(52) U.S. Cl. CPC F03D 9/007; H02K 7/183; F03D 9/25; F03D 9/008

(57) ABSTRACT

The present invention relates to a wind-water-light-magnetism-air five-energy integrated power generation device that comprises fan blades, a power generation device and a rotary shaft and further comprises a base, guide rail posts, fan blade rails and a tower. The barrel-shaped tower is concentrically and externally sleeved with the rotary shaft and is vertically fixed at the top of the base. The fan blade rails are disposed concentrically with the rotary shaft above the base, the guide rail posts are vertically fixed around the base two ends of the elongated fan blades are respectively fixed on the corresponding positions of the upper and lower guide rails, the top of the rotary shaft protrudes from the tower, and the protruding section of the rotary shaft is fixedly connected with the fan blades through two ends of a rod-shaped tower rod.

### FIELD OF THE INVENTION

The present invention relates to a wind-water-light-magnetism-air live-energy integrated power generation device.

### BACKGROUND OF THE INVENTION

As china is currently making great efforts to promote low-carbon environment-friendly technologies, its people have already attained tremendous progress in this aspect, especially in developing many products related to power generators, e.g. photovoltaic power generation, hydroelectric power generation, wind power generation and the like. Thermal power generation, however, is still the most efficient power generation method of all. The reason for this is that these other method s have low efficiency in converting energy into electric power and are highly targeted. In an attempt to better meet the requirements for low-carbon power generation, a need exits for a wind-water-light-magnetism-air five-energy integrated power generation device to address such technical problems as low power generation efficiency and poor comprehensive effectiveness.

### SUMMARY OF THE INVENTION

It is an object of the present invention to provide a wind-water-light-magnetism-air five-energy integrated power generation device, aiming at addressing such technical problems of low power generation efficiency and poor comprehensive effectiveness.

The following technical solution is adopted in the present invention.

A wind-water-light-magnetism-air five-energy integrated power generation device comprises fan blades (1), a power generation device (2), a rotary shaft (3) and an electric control system, and further comprises a base (4), guide rail posts (5), fan blade rails (6) and a tower (7). The base (4) is an enclosed hollow shell in which the rotary shaft (3) is centered vertically, the barrel-shaped tower (7) is concentrically and externally sleeved with the rotary shaft (3) and is vertically fixed at the top of the base (4). A coil or a magnet is disposed on the tower (7), disposed at a position corresponding to that of the rotary shaft (3) on the coil or the magnet is a magnet or a coil generating electromagnetic induction with the coil or the magnet so as to form the power generation device together with the tower (7). The circular fan blade rails (6) parallel to each other in a vertical direction are disposed concentrically with the rotary shaft (3) above the base (4). The guide rail posts (5) are vertically fixed around the base (4). The guide rail posts (5) are fixed on the base (4) to support and fix the fan blade rails (6). The fan blade rails (6) are provided thereon with guide rails (8) rotating along the fan blade rails (6), and two ends of the fan blades (1) are fixed respectively on the guide rails (8) positioned correspondingly with each other in a vertical direction. The plurality of fan blades (1) are arranged along the circumference of the fan blade rails (6), and the top of the rotary shaft (3) protrudes from the tower (7), and the protruding section of the rotary shaft (3) is fixedly connected with the fan blades (1) through a rod-shaped tower rod (9).

The fan blade rails (6) are disposed in the firm of multiple side-by-side rails. The fan blades on each of the fan blade rails (6) slide within the fan blade rails (6) and are controlled by the electric control system to unfold or overlap.

A lower end of the rotary shaft (3) is inserted into the base (4). The rotary shaft (3) located inside the base (4) is provided with blade paddles (31) along the axial circumference thereof. The base (4) is connected with a water inlet (41), an air inlet (42), a water outlet (43) and an air outlet (44). The air inlet (42) is externally connected with an air source and the water inlet (41) is externally connected with a water source. Water or air flowing into the water inlet (41) and the air inlet (42) pushes the blade paddles (31), and the blade paddles (31) drive the rotation of the rotary shaft (3).

The water outlet (43) is connected with the water inlet of a water feeder. The water outlet of the water feeder is connected with the water inlet (41) of the base (4) to form a water circulation passage. The air source is an inflator (10), and an inflating pressing plate (101) is disposed on an inflating lever of the inflator.

The fan blade rails (6) are provided thereon with a magnet to create a magnetic field function enabling the rotation of the rotary shaft (3).

The surface of the fan blades (1) is a photovoltaic panel.

The top of the tower (7) and the rotary shaft (3), as well as the base (4) and the rotary shaft (3) are in transmission connection with each other via a beating, respectively.

The fan blades (1) have are-shaped cross section.

The present invention has the following advantages:

1. The fan blades in this device not only have a good aerodynamic configuration, but also are simple in structure and high in reliability. The fan blades can obtain a relatively large lift force and a relatively small drag force (i.e. a relatively high lift-to-drag ratio) when an airflow flows through them. Under other specific conditions, a higher lilt-to-drag ratio results in a larger transmission torque, thus bringing a higher output power. The power generation device with small starting torque can be started up at a wind velocity of 4 m/s, which accordingly reduces the rotational drag farce for the fan blades and the cross-arm rotary shalt.

2. The structure and mode of connection of the fan blades, the rotary shall and the fan blade rails participate in carrying most of the rotary dynamic load, while at the same time overcoming loss of torque caused by large coaxiality error or asynchronous rotating speeds. Thus, overall rigidity and power requirement are guaranteed. The problem of insufficient fixation strength and rigidity in large equipment is solved fundamentally.

3. Having the capability to convert five energies, i.e. wind, water, light, magnetism and air, into electric power, this device integrates multiple collection means into single equipment, and also realizes the function of effective utilization of five renewable energies to improve the energy conversion efficiency of power generator significantly.

### BRIEF DESCRIPTION OF THE DRAWINGS

FIG. 1 is a schematic view illustrating the overall structure of the present invention;

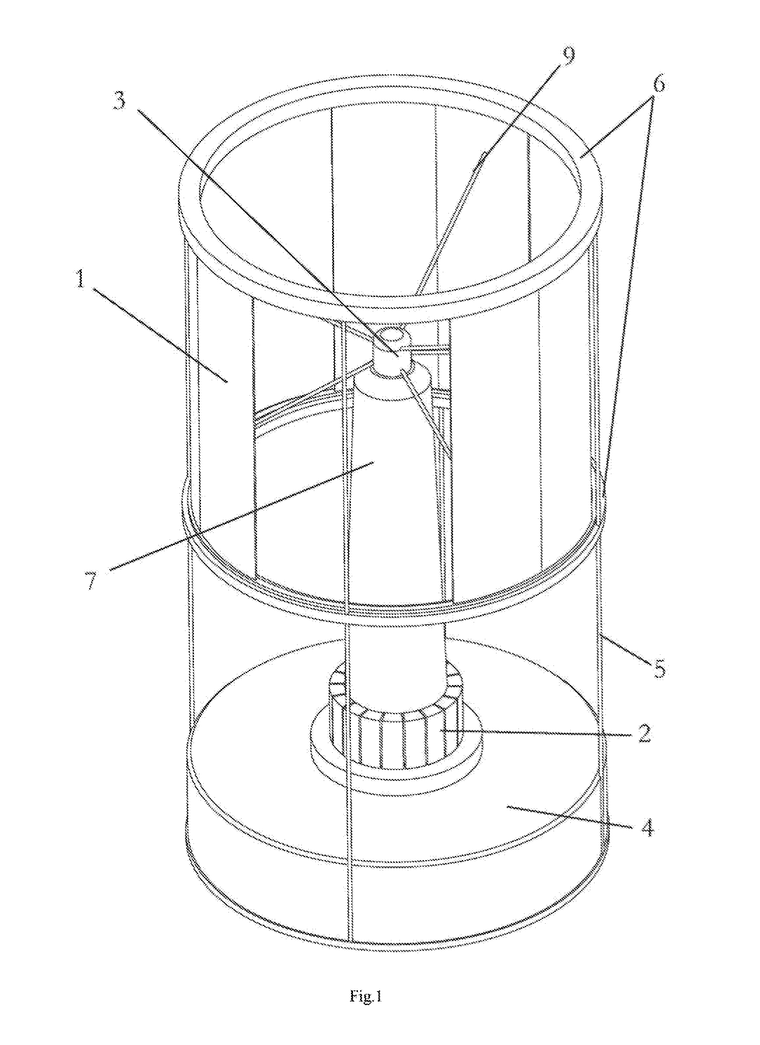

FIG. 2 is a schematic front view of the present invention;

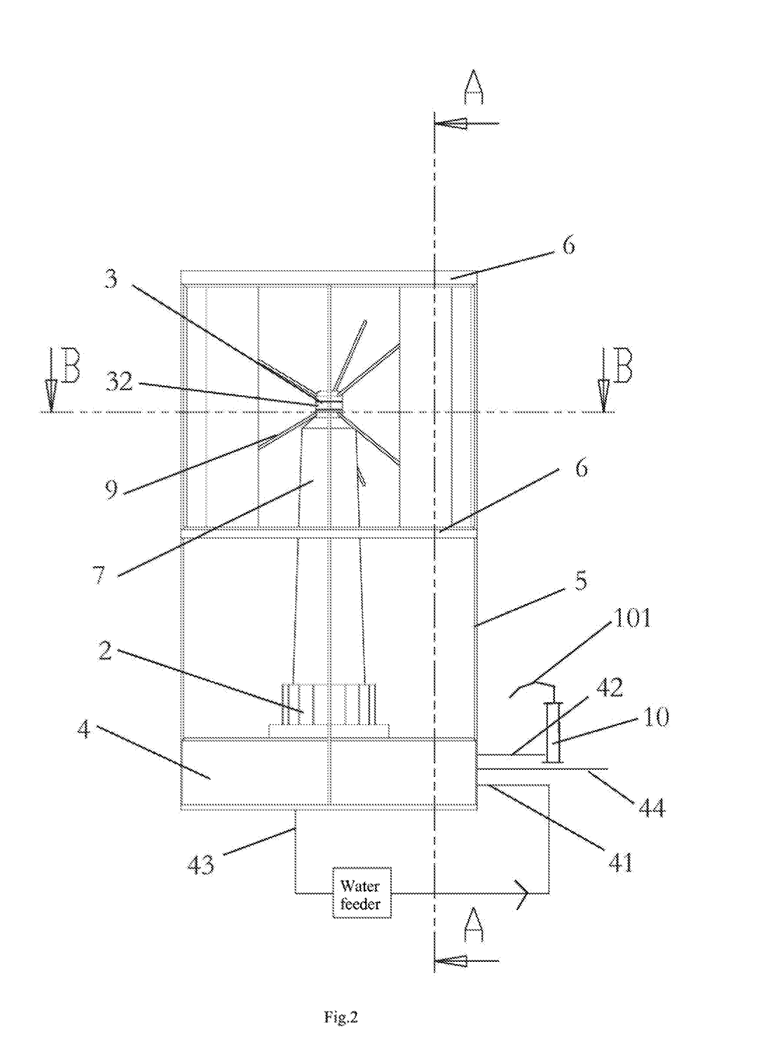

FIG. 3 is a schematic view illustrating a section A-A of the present invention;

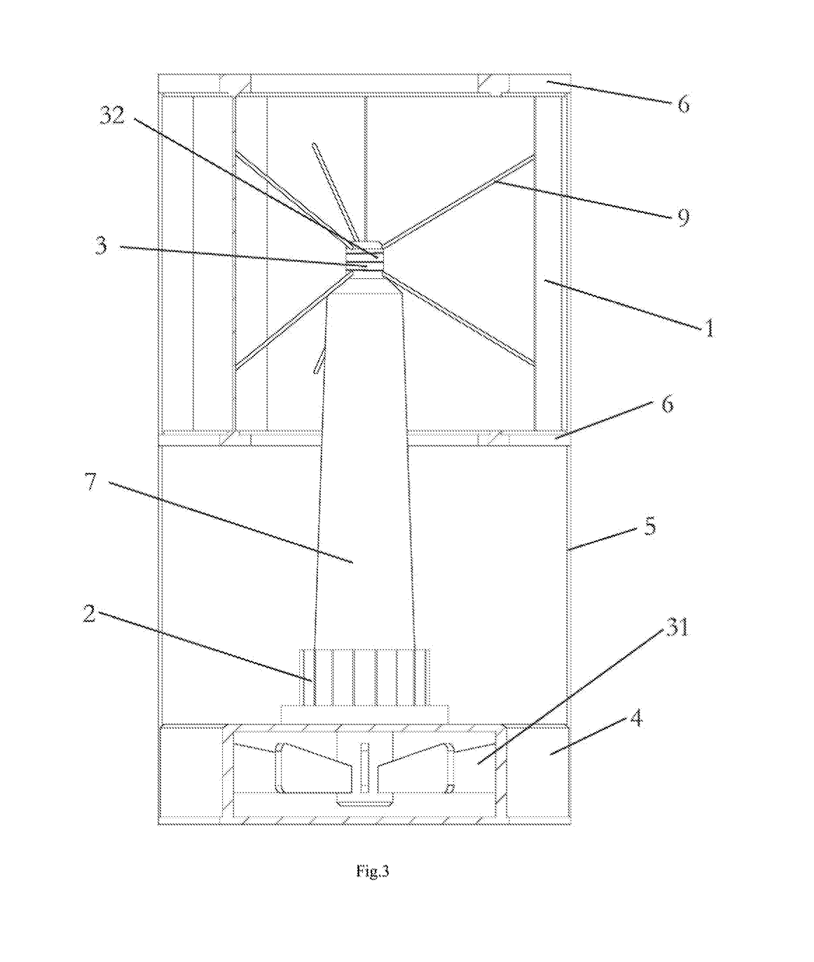

FIG. 4 is a schematic view illustrating a section B-B of the present invention;

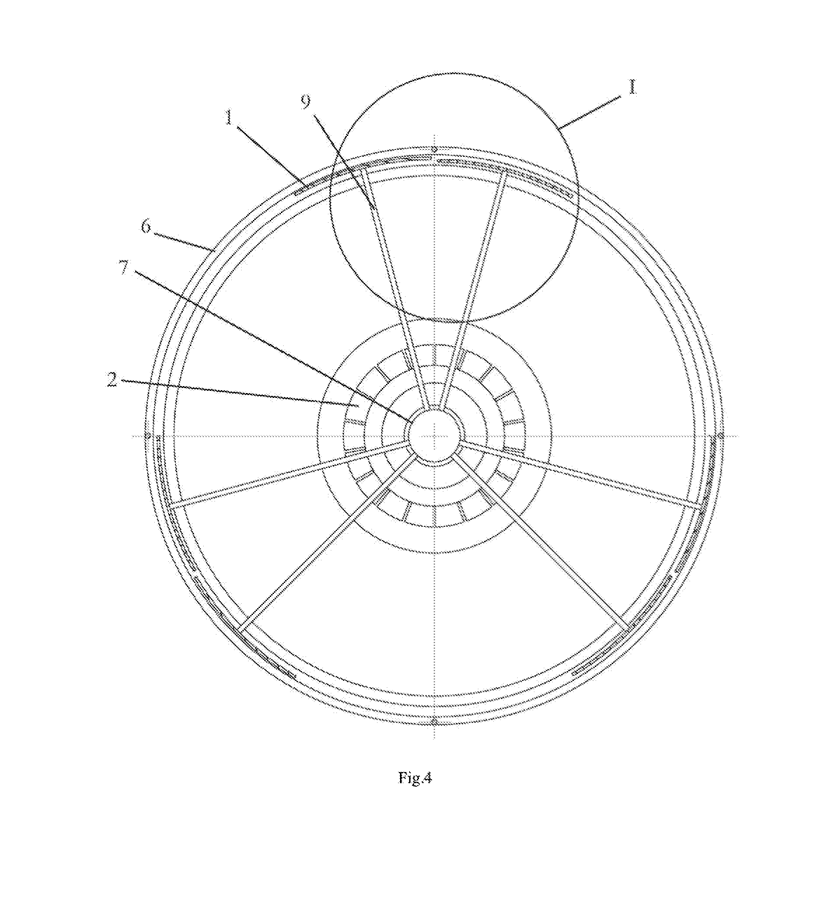

FIG. 5 is an enlarged schematic view illustrating a portion I of the present invention; and

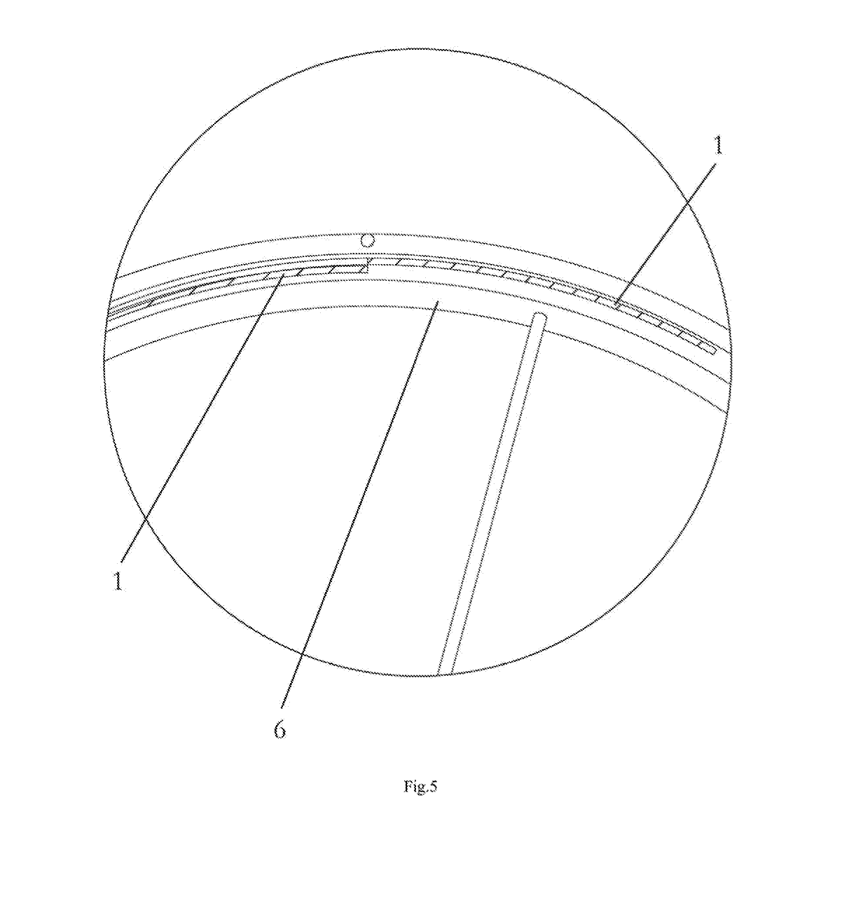

FIG. 6 is a schematic view illustrating installation of a fan-blade-and-fan-blade-rail structure of the present invention.

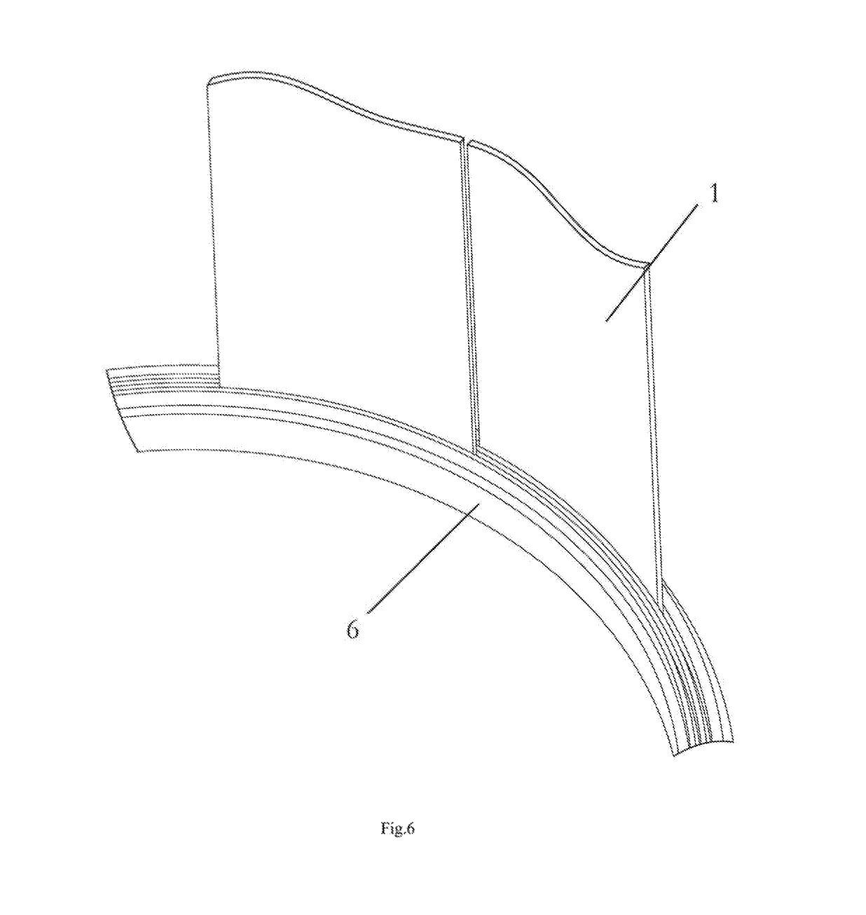

### DETAILED DESCRIPTION OF THE INVENTION

The embodiments of the present invention will be further described below with reference to the accompanying drawings.

The embodiments below are merely examples given for a clear description of the present invention, rather than limiting the implementations of the present invention. For those ordinary skilled in this art, other variations or alterations in different forms could also be made on the basis of the description hereinafter. These obvious variations or alterations derived from the spirit of the present invention still fall within the scope of protection of the present invention.

A wind-water-light-magnetism-air five-energy integrated power generation device comprises fan blades 1, a power generation device 2, a rotary shaft 3 and an electric control system, and further comprises a base 4, guide rail posts 5, fan blade rails 6 and a tower 7; the base 4 is an enclosed hollow shell in which the rotary shaft 3 is centered vertically, the barrel-shaped tower 7 is concentrically and externally sleeved with the rotary shall 3 and is vertically fixed at the top of the base 4, a coil or a magnet is disposed on the tower 7 to form a stator, disposed at a position corresponding to that of the rotary shall 3 or the fan blades 1 on the coil or the magnet is a magnet or a coil generating electromagnetic induction with coil or the magnet to form a rotor, so as to form the power generation device together with the tower 7, the circular fan blade rails 6 parallel to each other in a vertical direction are disposed concentrically with the rotary shaft 3 above the base 4, the guide rail posts 5 are vertically fixed around the base 4, the guide rail posts 5 are fixed on the base 4 to support and fix the fan blade rails 6, the fan blade rails 6 are provided thereon with guide rails 8 rotating along the fan blade rails 6, and two ends of the fan blades 1 are fixed respectively on the guide rails 8 positioned correspondingly with each other in a vertical direction, the plurality of fan blades 1 are arranged along the circumference of the fan blade rails 6, and the top of the rotary shaft 3 protrudes from the tower 7, and the protruding section of the rotary shaft 3 is fixedly connected with the fan blades 1 through a rod-shaped tower rod 9.

The fan blade rails 6 are disposed in the form of multiple side-by-side rails. The fan blades on each fan blade rails 6 slide within the fan blade rails 6 and are controlled by the electric control system to unfold or overlap.

A lower end of the rotary shaft 3 is inserted into the base 4. The rotary shaft 3 located inside the base 4 is provided with blade paddles 31 along the axial circumference thereof. The base 4 is connected with a water inlet 41, an air inlet 42, a water outlet 43 and an air outlet 44, and the air inlet 42 is externally connected with an air source. The water inlet 41 is externally connected with a water source. Water or air flowing into the water inlet 41 and the air inlet 42 pushes the blade paddles 31, and the blade paddles 31 drive the rotation of the rotary shaft 3.

The water outlet 43 is connected with the water inlet of a water feeder. The water outlet of the water feeder is connected with the water inlet 41 of the base 4 to form a water circulation passage. The air source is an inflator 10, and an inflating pressing plate 101 is disposed on an inflating lever of the inflator.

The fan blade rails 6 are provided thereon with a magnet to create a magnetic field function enabling the rotation of the rotary shaft 3.

Each surface of the fan blades 1 is a photovoltaic panel.

The top of the tower 7 and the rotary shaft 3, as well as the base 4 and the rotary shaft 3 are in transmission connection with each other via a bearing, respectively.

The fan blades 1 have arc-shaped cross section.

The method of using this device is specifically as follows:

The parts of the device are made from lightweight alloy materials and the weight of wind turbine members is effectively reduced accordingly. As demonstrated by data that is actually measured in the field, this wind-water-light-magnetism-air live-energy integrated power generation device has small starting torque and can be started up in a reliable way at a wind velocity of 4 m/s.

Meanwhile, the structure and mode of connection of the fan blades 1, the rotary shaft 3 and the fan blade rails 6 enable the dispersal of the stress points of rotational vibration, and it is also ensured that there is no judder and resonance phenomenon on the top of a safe wind velocity range.

The practicability of large-diameter fan blade systems is enhanced, and their operating failure rate is decreased by 10% to 20% as compared to conventional vertical-axis power generation systems.

This device also possesses an automatic pitch mode. As typhoon, hurricane, or other strong winds having a wind velocity of more than 20 m/s approaches, the fan blades 1 unfold or overlap such that the included angle between each group of fan blades 1 is substantially reduced. By doing this, the impact of these strong winds upon the fan blades is diminished remarkably, so as to ensure the safety of this device. Practices have proven that such a structure is able to fight against strong winds efficiently. Furthermore, the results of repeated structural strength analyses conducted under a 1.5-fold full load have indicated that due to the high-strength structural framework, the system's safety and reliability can be ensured even at a wind velocity of 60 m/s (i.e. wind force 17). And according to the modal analysis over this structure, the conclusion is draw that it can ensure the absence of the resonance phenomenon within a safe wind velocity range. As for specific weather and environment conditions along coastal areas and on islands, all the components of this device have been subjected to salt spray-resistant, moisture-proof and fungus-proof treatments, and all the outdoor metal components have undergone a deep anticorrosive coating treatment for ships.

Transferring the power generation device to the ground raises the strength of tower rod greatly, lowers installation difficulty, workload and subsequent maintenance expenses, and facilitates maintenance work in the future. In a certain sense, the service ability of field equipment of the entire power generation system increases as well.

Depending on the requirements from clients and also on specific weather conditions on islands, the device of the present invention utilizes five renewable energies for power generation on the premise that its height is restricted to be below 60 m and rated power is guaranteed to be reached. And the device has the benefit of high energy conversion efficiency.

What is claimed is:

1. A wind-water-light-magnetism-air five-energy integrated power generation device, comprising fan blades (1), a power generation device, a rotary shaft (3) and an electric control system;
wherein the integrated power generation device further comprises a base (4), guide rail posts (5), fan blade rails (6) and a tower (7);
wherein the base (4) is an enclosed hollow shell in which the rotary shaft (3) is centered vertically; the barrel-shaped tower (7) is concentrically and externally sleeved with the rotary shaft (3) and is vertically fixed at the top of the base (4); a coil or a magnet is disposed on the tower (7), disposed at a position corresponding to that of the rotary shaft (3) or the fan blades (1) on the coil or the magnet is a magnet or a coil generating electromagnetic induction with the coil or the magnet, so as to form the power generation device together with the tower (7), the circular fan blade rails (6) parallel to each other in a vertical direction are disposed concentrically with the rotary shaft (3) above the base (4), the guide rail posts (5) are vertically fixed around the base (4), the guide rail posts (5) are fixed on the base (4) to support and fix the fan blade rails (6), the fan blade rails (6) are provided thereon with guide rails (8) rotating along the fan blade rails (6), and two ends of the fan blades (1) are fixed respectively on the guide rails (8) positioned correspondingly with each other in a vertical direction, the plurality of fan blades (1) are arranged along the circumference of the fan blade rails (6), and the top of the rotary shaft (3) protrudes from the tower (7), and the protruding section of the rotary shaft (3) is fixedly connected with the fan blades (1) through a rod-shaped tower rod (9).

2. The wind-water-light-magnetism-air five-energy integrated power generation device according to claim 1, characterized in that the fan blade rails (6) are disposed in the form of multiple side-by-side rails, the fan blades on each fan blade rail (6) slide within the fan blade rail (6) and are controlled by the electric control system to unfold or overlap.

3. The wind-water-light-magnetism-air five-energy integrated power generation device according to claim 1, characterized in that a lower end of the rotary shaft (3) is inserted into the base (4), the rotary shalt (3) located inside the base (4) is provided with blade paddles (31) along the axial circumference thereof, the base (4) is connected with a water inlet (41), an air inlet (42), a water outlet (43) and an air outlet (44), the air inlet (42) is externally connected with an air source, the water inlet (41) is externally connected with a water source, water or air flowing into the water inlet (41) and the air inlet (42) pushes the blade paddles (31), and the blade paddles (31) drive the rotation of the rotary shaft (3).

4. The wind-water-light-magnetism-air five-energy integrated power generation device according to claim 3, characterized in that the water outlet (43) is connected with the water inlet of a water feeder; the water outlet of the water feeder is connected with the water inlet (41) of the base (4) to form a water circulation passage, the air source is an inflator (10), and an inflating pressing plate (101) is disposed on an inflating lever of the inflator.

5. The wind-water-light-magnetism-air five-energy integrated power generation device according to claim 4, characterized in that the fan blade rails (6) are provided thereon with a magnet to create a magnetic field function enabling the rotation of the rotary shaft (3).

6. The wind-water-light-magnetism-air five-energy integrated power generation device according to claim 1, characterized in that a surface of the fan blades (1) is a photovoltaic panel.

7. The wind-water-light-magnetism-air five-energy integrated power generation device according to claim 1, characterized in that the top of the tower (7) and the rotary shaft (3), as well as the base (4) and the rotary shaft (3) are in transmission connection with each other via a bearing, respectively.

8. The wind-water-light-magnetism-air five-energy integrated power generation device according to claim 7, characterized in that the fan blades (1) have an arc-shaped cross section.
